(19) United States
(12) Patent Application Publication
(10) Pub. No.: US 2007/0215547 A1
(43) Pub. Date: Sep. 20, 2007

(54) Porous Hybrid Monolith Materials With Organic Groups Removed From the Surface

(75) Inventor: John E. O'Gara, Ashland, MA (US)

Correspondence Address: EDWARDS & ANGELL, LLP, P.O. BOX 55874, BOSTON, MA, 02205, US

(73) Assignee: Waters Investments Limited, New Castle, DE (US)

(21) Appl. No.: 10/587,598

(22) PCT Filed: Feb. 16, 2005
(86) PCT No.: PCT/US05/04955

§ 371 Date: Apr. 27, 2007

Related U.S. Application Data
(60) Provisional application No. 60/545,590, filed on Feb. 17, 2004.

(51) Int. Cl. B32B 3/10

(52) U.S. Cl. 210/656; 210/198.2; 210/198.3; 210/502.1; 516/104

(57) ABSTRACT

A material for chromatographic separations, processes for its preparation, and separation devices containing the chromatographic material. In particular, porous inorganic/organic hybrid monoliths are provided with a decreased concentration of surface organic groups, and have improved pH stability, improved chromatographic separation performance, and improved packed bed stability. These monoliths may be surface modified resulting in higher bonded phase surface concentrations and have enhanced stability at low pH.

### RELATED APPLICATION

This application claims priority to U.S. provisional patent application Ser. No. 60/545,590, filed Feb. 17, 2004 (attorney docket no. 49991-59894P; Express Mail Label No. EV438969104US), which application is incorporated herein in its entirety by this reference.

### BACKGROUND OF THE INVENTION

Packing materials for liquid chromatography (LC) are generally classified into two types: those having organic or polymeric carriers, e.g., polystyrene polymers; and those having inorganic carriers typified by silica gel. The polymeric materials are chemically stable against alkaline and acidic mobile phases; therefore, the pH range of the eluent used with polymeric chromatographic materials is wide, compared with the silica carriers. However, polymeric chromatographic materials generally result in columns having low efficiency, leading to inadequate separation performance, particularly with low molecular-weight analytes. Furthermore, polymeric chromatographic materials shrink and swell upon solvent changeover in the eluting solution.

On the other hand, silica gel-based chromatographic devices, e.g., HPLC columns, are most commonly used. The most common applications employ a silica which has been surface-derivatized with an organic functional group such as octadecyl (C₁₈), octyl (C₈), phenyl, amino, cyano (CN) group, etc. As a stationary phase for HPLC, these packing materials result in columns with high theoretical plate number/high efficiency, and do not evidence shrinking or swelling. Silica gel is characterized by the presence of silanol groups on its surface. During a typical derivatization process such as reaction with octadecyldimethylchlorosilane, at least 50% of the surface silanol groups remain unreacted.

Packing materials for liquid chromatography (LC) are generally classified into two types: those having organic or polymeric carriers, e.g., polystyrene polymers; and those having inorganic carriers typified by silica gel. The polymeric materials are chemically stable against alkaline and acidic mobile phases; therefore, the pH range of the eluent used with polymeric chromatographic materials is wide, compared with the silica carriers. However, polymeric chromatographic materials generally result in columns having low efficiency, leading to inadequate separation performance, particularly with low molecular-weight analytes. Furthermore, polymeric chromatographic materials shrink and swell upon solvent changeover in the eluting solution.

On the other hand, silica gel-based chromatographic devices, e.g., HPLC columns, are most commonly used. The most common applications employ a silica which has been surface-derivatized with an organic functional group such as octadecyl (C₁₈), octyl (C₈), phenyl, amino, cyano (CN) group, etc. As a stationary phase for HPLC, these packing materials result in columns with high theoretical plate number/high efficiency, and do not evidence shrinking or swelling. Silica gel is characterized by the presence of silanol groups on its surface. During a typical derivatization process such as reaction with octadecyldimethylchlorosilane, at least 50% of the surface silanol groups remain unreacted.

A drawback with silica-based columns is their limited hydrolytic stability. First, the incomplete derivatization of the silica gel leaves a bare silica surface which can be readily dissolved under alkaline conditions, generally pH>8.0, leading to the subsequent collapse of the chromatographic bed. Secondly, the bonded phase can be stripped off of the surface under acidic conditions, generally pH<2.0, and eluted off the column by the mobile phase, causing loss of analyte retention, and an increase in the concentration of surface silanol groups. To address to these problems, many methods have been tried including the use of ultra pure silica, carbonized silica, coating of the silica surface with polymeric materials, and end-capping free silanol groups with a short-chain reagent such as trimethylchlorosilane. These approaches have not proven to be completely satisfactory in practice.

Hybrid particles offer, potentially, the benefits of both silica and organic based materials. Hybrid particles are described, for example, in U.S. Pat. No. 4,017,528. Porous inorganic/organic hybrid particles having chromatographically enhanced pore geometry are described in WO 00/03052, WO 03/022392 and U.S. Pat. No. 6,686,035.

Although hybrid particles offer certain advantages, they also have certain limitations that can be attributed to the organic groups on the surface of the particle (e.g., methyl groups). In particular, the presence of surface organic groups can lead to lower bonded phase surface concentrations after bonding with silanes, e.g., C₁₈ and C₈ silanes, in comparison to silica phases, presumably because the organic groups on the surface are unreactive to bonding. Further, in bonded phases prepared from multifunctional silanes (e.g. dichlorodialkylsilanes, trichloroalkylsilanes), particle surface organic groups may decrease the level of cross-bonding between adjacent alkyl bonded phase ligands. This results in reduced low pH stability because the alkyl ligand has fewer covalent bonds to the surface of the particle. Ultimately, reduced retention times and peak compression can result from the reduced low pH stability caused by surface organic groups.

Porous inorganic/organic hybrid particles having organic groups removed from the surface are described in WO 02/060562 and in U.S. Pat. No. 6,528,167. These particles overcome the limitations associated with particle surface organic groups.

However, a further problem associated with silica particles and hybrid silica particles is packed bed stability. Chromatography columns packed with spherical particles can be considered to be random close packed lattices in which the interstices between the particles form a continuous network from the column inlet to the column outlet. This network forms the interstitial volume of the packed bed which acts as a conduit for fluid to flow through the packed column. In order to achieve maximum packed bed stability, the particles must be tightly packed, and hence, the interstitial volume is limited in the column. As a result, such tightly packed columns afford high column backpressures which are not desirable. Moreover, bed stability problems for these chromatography columns are still typically observed, because of particle rearrangements.

Monolith materials have been developed in an attempt to overcome the problem of packed bed stability. These include polymeric monoliths such as polymethacrylate monoliths (U.S. Pat. No. 5,453,185, U.S. Pat. No. 5,728,457); polystyrene—DVB monoliths (U.S. Pat. No. 4,889,632, U.S. Pat. No. 4,923,610, U.S. Pat. No. 4,952,349); charge incorporated polymethacrylate monoliths for the application of reversed-phase ion-pairing chromatography (U.S. Pat. No. 6,238,565); monoliths based on ROMP metathesis (WO 00073782); and (EP 852334) continuous monolith columns made from water-soluble polymerizable monomers, such as vinyl, allyl, acrylic and methacrylic compounds, without porogens but in the presence of high concentration of inorganic salts such as ammonium sulfate.

Polymeric monoliths are chemically stable against strongly alkaline and strongly acidic mobile phases, allowing flexibility in the choice of mobile phase pH. However, the lower efficiencies of the polymeric as compared with inorganic monoliths results in inadequate separation performance, particularly with low molecular-weight analytes. As a result of the swelling properties of the polymeric monoliths, the composition of the mobile phase is limited. Despite the fact that polymeric monoliths of many different compositions and processes have been explored, no solutions have been found to these problems.

Inorganic, e.g., silica-based, analogs of monolith columns include those disclosed in U.S. Pat. No. 5,624,875, WO 98/29350, U.S. Pat. No. 6,207,098 B1, and U.S. Pat. No. 6,210,570. Inorganic silica monoliths are mechanically very strong and do not show evidence of shrinking and swelling. They exhibit significantly higher efficiencies than their polymeric counterparts in chromatographic separations. However, silica monoliths suffer from a major disadvantage: silica dissolves at alkaline pH values. Because the variation of the pH is one of the most powerful tools in the manipulation of chromatographic selectivity, there is a need to expand the use of chromatographic separations into the alkaline pH range for monolith materials, without sacrificing efficiencies.

A new generation of porous inorganic/organic hybrid monoliths having chromatographically enhanced pore geometry is described in WO 03/014450. These monoliths have overcome many of the limitations associated with the monoliths described above.

Nevertheless, prior art hybrid monoliths suffer from many of the same limitations caused by the presence of surface organic groups, as described above for hybrid particles. Foremost among these limitations is low bonded phase surface concentrations after bonding, reduced low pH stability, reduced retention times and peak compression.

Therefore, a chromatographic hybrid monolith material that has increased bonded phase surface concentrations and reduces or eliminates the reduced retention times and peak compression caused by surface organic groups without high column backpressures is needed.

### SUMMARY OF THE INVENTION

The present invention relates to improved porous inorganic/organic hybrid monolith chromatographic materials which demonstrate higher bonded phase surface concentrations, improved stability and separation characteristics. The chromatographic hybrid-monolith materials can be used for performing separations or for participating in chemical reactions. The monoliths according to the invention feature a surface with a desired bonded phase, e.g., octadecyldimethylchlorosilane (ODS) or CN, and a controlled surface concentration of silicon-organic groups. More particularly, surface silicon-organic groups are selectively replaced with silanol groups, thereby reducing surface organic groups that interfere with low pH stability. In addition, the monolithic structure of the materials provides the stability associated with a tightly packed particle bed without the undesirable high column backpressures. By combining the features of monolithic structure and reduction of organic groups on the surface, the invention provides hybrid monolith materials having substantially increased bonded phase surface concentrations, improved pH stability and improved chromatographic separation performance.

Thus, in one aspect, the invention provides porous inorganic/organic hybrid monoliths that have an interior area and an exterior surface and are represented by:
[A]_{y}[B]ₓ (Formula I)

where x and y are whole number integers and A is represented by:
SiO₂/(R¹ₚR²_{q}SiOₜ)ₙ (Formula II), and/or SiO₂/[R³(R¹ᵣSiOₜ)ₘ]ₙ (Formula III);

where R¹ and R² are independently a substituted or unsubstituted C₁ to C₇ alkyl group or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q 1, t=1.5, and when p+q=2, t=1; r is 0 or 1, provided that when r=0, t=1.5, and when r=1, t=1; m is an integer greater than or equal to 2; and n is a number from 0.01 to 100. B is represented by:
SiO₂/(R⁴ᵥSiOₜ)ₙ (Formula IV)

where W⁴ may be hydroxyl, fluorine, alkoxy (e.g., methoxy), aryloxy, substituted siloxane, protein, peptide, carbohydrate, nucleic acid, and combinations thereof, and R⁴ is not R¹, R², or R³, v is 1 or 2, provided that when v=1, t=1.5, and when v=2, t=1; and n is a number from 0.01 to 100. The interior of the monolith has a composition of A, the exterior surface of the monolith has a composition represented by A and B, and the exterior composition is between about 1 and about 99% of the composition of B and the remainder including A. In these monoliths, R⁴ may be represented by:
—OSi(R⁵)₂—R⁶ (Formula V)

where R⁵ may be a C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C₁₈, cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities.

In one embodiment, the surface concentration R⁶ may greater than about 1.0 μmol/m², more preferably greater than about 2.0 μmol/m², and still more preferably greater than about 3.0 μmol/m². In a preferred embodiment, the surface concentration of R⁶ is between about 1.0 and about 3.4 μmol/m².

In another aspect, the invention provides a method for performing a separation of components in a sample. The method comprises contacting the sample with the chromatographic material of the invention. In one embodiment, the sample is passed through a chromatographic column containing the chromatographic material of the invention.

In yet another aspect, the invention provides a separation device comprising the chromatographic material of the invention.

In a further aspect, the invention provides a process for preparing the chromatographic material of the invention. The process comprises the steps of:

a) preparing an aqueous solution of a mixture of one or more organoalkoxysilanes and a tetraalkoxysilane in the presence of an acid catalyst, and a surfactant or combination of surfactants to produce a polyorganoalkoxysiloxane;

b) incubating said solution, resulting in a three-dimensional gel having a continuous, interconnected pore structure;

c) aging the gel at a controlled pH and temperature to yield a solid monolith material;

d) rinsing the monolith material with an aqueous basic solution at an elevated temperature;

e) rinsing the monolith material with water followed by a solvent exchange;

f) drying the monolith material at room temperature drying and at an elevated temperature under vacuum; and

g) replacing one or more surface C₁ to C₇ alkyl groups, substituted or unsubstituted aryl groups, substituted or unsubstituted C₁ to C₇ alkylene, alkenylene, alkynylene, or arylene groups of the monolith with hydroxyl, fluorine, alkoxy, aryloxy, or substituted siloxane groups.

In a related aspect, the invention provides chromatographic materials of the invention having been prepared by a process comprising the steps of:

a) preparing an aqueous solution of a mixture of one or more organoalkoxysilanes and a tetraalkoxysilane in the presence of an acid catalyst, and a surfactant or combination of surfactants to produce a polyorganoalkoxysiloxane;

b) incubating said solution, resulting in a three-dimensional gel having a continuous, interconnected pore structure;

c) aging the gel at a controlled pH and temperature to yield a solid monolith material;

d) rinsing the monolith material with an aqueous basic solution at an elevated temperature;

e) rinsing the monolith material with water followed by a solvent exchange;

f) drying the monolith material at room temperature drying and at an elevated temperature under vacuum; and

g) replacing one or more surface C₁ to C₇ alkyl groups, substituted or unsubstituted aryl groups, substituted or unsubstituted C₁ to C₇ alkylene, alkenylene, alkynylene, or arylene groups of the monolith with hydroxyl, fluorine, alkoxy, aryloxy, or substituted siloxane groups.

In yet another aspect, the invention provides a method of forming a porous inorganic/organic hybrid monolith comprising:
(a) forming a porous inorganic/organic hybrid monolith having surface silicon-alkyl groups;
(b) replacing one or more surface silicon-alkyl groups of the hybrid monolith with hydroxyl groups;
(c) replacing one or more surface silicon-alkyl groups with halo groups;
(d) bonding one or more substituted siloxane groups to the surface of the hybrid monolith; and
(e) end-capping the surface of the hybrid monolith with trialkylhalosilane.

### DETAILED DESCRIPTION OF THE INVENTION

Definitions

The present invention will be more fully understood by reference to the definitions set forth below.

The term “monolith” is intended to include a porous, three-dimensional material having a continuous interconnected pore structure in a single piece. A monolith is prepared, for example, by casting precursors into a mold of a desired shape. The term monolith is meant to be distinguished from a collection of individual particles packed into a bed formation, in which the end product comprises individual particles.

The terms “coalescing” and “coalesced” are intended to describe a material in which several individual components have become coherent to result in one new component by an appropriate chemical or physical process, e.g., heating. The term coalesced is meant to be distinguished from a collection of individual particles in close physical proximity, e.g., in a bed formation, in which the end product comprises individual particles.

The term “incubation” is intended to describe the time period during the preparation of the inorganic/organic hybrid monolith material in which the precursors begin to gel.

The term “aging” is intended to describe the time period during the preparation of the inorganic/organic hybrid monolith material in which a solid rod of monolithic material is formed.

The term “macropore” is intended to include pores of a material that allow liquid to flow directly through the material with reduced resistance at chromatographically-useful flow rates. For example, macropores of the present invention are intended to include, but are not limited to pores with a pore diameter larger than about 0.05 μm, pores with a pore diameter ranging from about 0.05 μm to about 100 μm, pores with a pore diameter ranging from about 0.11 μm to about 100 μm, and pores with a pore diameter ranging from about 0.5 μm to about 30 μm.

The term “chromatographically-useful flow rates” is intended to include flow rates that one skilled in the art of chromatography would use in the process of chromatography.

The language “chromatographically-enhancing pore geometry” includes the geometry of the pore configuration of the presently-disclosed porous inorganic/organic hybrid materials, which has been found to enhance the chromatographic separation ability of the material, e.g., as distinguished from other chromatographic media in the art. For example, a geometry can be formed, selected or constructed, and various properties and/or factors can be used to determine whether the chromatographic separations ability of the material has been “enhanced”, e.g., as compared to a geometry known or conventionally used in the art. Examples of these factors include high separation efficiency, longer column life, and high mass transfer properties (as evidenced by, e.g., reduced band spreading and good peak shape.) These properties can be measured or observed using art-recognized techniques. For example, the chromatographically-enhancing pore geometry of the present porous inorganic/organic hybrid monoliths is distinguished from prior art monoliths by the absence of “ink bottle” or “shell shaped” pore geometry or morphology, both of which are undesirable because they, e.g., reduce mass transfer rates, leading to lower efficiencies.

Chromatographically-enhancing pore geometry is found in hybrid materials, e.g., particles or monoliths, containing only a small population of micropores and a sufficient population of mesopores. A small population of micropores is achieved in hybrid materials when all pores of a diameter of about <34 Å contribute less than about 110 m²/g to the specific surface area of the material. Hybrid materials with such a low micropore surface area give chromatographic enhancements including high separation efficiency and good mass transfer properties (as evidenced by, e.g., reduced band spreading and good peak shape). Micropore surface area is defined as the surface area in pores with diameters less than or equal to 34 Å, determined by mulitpoint nitrogen sorption analysis from the adsorption leg of the isotherm using the BJH method.

A sufficient population of mesopores is achieved in hybrid materials when all pores of a diameter of about 35 Å to about 500 Å, e.g., preferably about 60 Å to about 500 Å, e.g., even more preferably about 100 Å to about 300 Å, sufficiently contribute to the specific surface area of the material, e.g., to about 50 to about 800 m²/g, e.g., preferably about 75 to about 650 m²/g, e.g., even more preferably about 190 to about 520 m²/g to the specific surface area of the material.

The term “hybrid” as in “porous inorganic/organic hybrid monolith” includes inorganic-based structures wherein an organic functionality is integral to both the internal or “skeletal” inorganic structure as well as the hybrid material surface. The inorganic portion of the hybrid material may be, e.g., alumina, silica, titanium or zirconium oxides, or ceramic material; in a preferred embodiment, the inorganic portion of the hybrid material is silica. In a preferred embodiment where the inorganic portion is silica, “hybrid silica” refers to a material having the formula SiO₂/(R²ₚR⁴_{q}SiOₜ)ₙ or SiO₂/[R⁶(R²ᵣSiOₜ)ₘ]ₙ wherein R² and R⁴ are independently C₁-C₁₈ aliphatic, styryl, vinyl, propanol, or aromatic moieties (which may additionally be substituted with alkyl, aryl, cyano, amino, hydroxyl, diol, nitro, ester, ion exchange or embedded polar functionalities), R⁶ is a substituted or unsubstituted C₁-C₁₈ alkylene, alkenylene, alkynylene or arylene moiety bridging two or more silicon atoms, p and q are 0, 1 or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2, and n is a number from 0.03 to 1, more preferably, 0.1 to 1, and even more preferably 0.2 to 0.5. R² may be additionally substituted with a functionalizing group R.

A “bonded phase” can be formed by adding functional groups to the surface of hybrid silica. The surface of hybrid silica contains silanol groups, that can be reacted with a reactive organosilane to form a “bonded phase”. Bonding involves the reaction of silanol groups at the surface of the hybrid monoliths with halo or alkoxy substituted silanes, thus producing a Si—O—Si—C linkage.

Generally, only a maximum of 50% of the Si—OH groups on heat-treated silica can react with the trimethylsilyl entity, and less with larger entities such as the octadecylsilyl groups. Factors tending to increase bonding coverage include: silanizing twice, using a large excess of silanizing reagent, using a trifunctional reagent, silanizing in the presence of an acid scavenger, performing secondary hydroxylation of the surface to be silanized, using a chlorinated solvent in preference to a hydrocarbon, and end-capping of the surface.

Some adjacent vicinal hydroxyls on the silica surface are at a distance such that difunctional reactions can occur between the silica surface and a difunctional or trifunctional reagent. When the adjacent hydroxyls on the silica surface are not suitably spaced for a difunctional reaction, then only a monofunctional reaction takes place.

Silanes for producing bonded silica include, in decreasing order of reactivity: RSiX₃, R₂SiX₂, and R₃SiX, where X is halo (e.g., chloro) or alkoxy. Specific silanes for producing bonded silica, in order of decreasing reactivity, include n-octyldimethyl(dimethylamine)silane (C₈H₁₇Si(CH₃)₂N(CH₃)₂), n-octyldimethyl(trifluoroacetoxy)silane (C₈H₁₇Si(CH₃)₂OCOCF₃), n-octyldimethylchlorosilane (C₈H₁₇Si(CH₃)₂Cl), n-octyldimethylmethoxysilane (C₈H₁₇—Si(CH₃)₂OCH₃), n-octyldimethylethoxysilane (C₈H₁₇Si(CH₃)₂OC₂H₅), and bis-(n-octyldimethylsiloxane) (C₈H₁₇Si(CH₃)₂OSi(CH₃)₂C₈H₁₇).

Other monochlorosilanes that can be used in producing bonded silica include: Cl—Si(CH₃)₂—(CH₂)ₙ—X, where X is H, CN, fluorine, chlorine, bromine, iodine, phenyl, cyclohexyl, or vinyl, and n is 0 to 30 (preferably 2 to 20, more preferably 8 to 18); Cl—Si(CH₃)₂—(CH₂)₈—H (n-octyldimethylsilyl); Cl—Si(CH(CH₃)₂)₂—(CH₂)ₙ—X, where X is H, CN, fluorine, chlorine, bromine, iodine, phenyl, cyclohexyl, or vinyl; and Cl—Si(CH(Phenyl)₂)₂-(CH₂)ₙ—X where X is H, CN, fluorine, chlorine, bromine, iodine, phenyl, cyclohexyl, or vinyl.

Dimethylmonochlorosilane (Cl—Si(CH₃)₂—R) can be synthesized by a 2-step process such as shown below.
CₙH₂ₙ₊₁—Br+Mg →CₙH₂ₙ₊₁—MgBr
CₙH₂ₙ₊₁MgBr+(CH₃)₂SiCl₂→CₙH₂ₙ₊₁Si(CH₃)₂Cl

Alternatively, dimethylmonochlorosilane (Cl—Si(CH₃)₂—R) can be synthesized by a one-step catalytic hydrosilylation of terminal olefins. This reaction favors formation of the anti-Markovnikov addition product. The catalyst used may be hexachloroplatinic acid-hexahydrate (H₂PtCl₆—6H₂O).

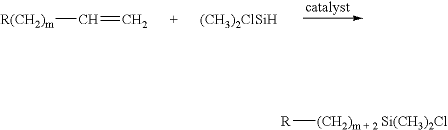

The surface derivatization of the hybrid silica is conducted according to standard methods, for example by reaction with octadecyldimethylchlorosilane in an organic solvent under reflux conditions. An organic solvent such as toluene is typically used for this reaction. An organic base such as pyridine or imidazole is added to the reaction mixture to catalyze the reaction. The product is then washed with water, toluene and acetone and dried at 100° C. under reduced pressure for 16 h.

The term “functionalizing group” includes organic groups which impart a certain chromatographic functionality to a chromatographic stationary phase, including, e.g., octadecyl (C₁₈) or phenyl. Such functionalizing groups are present in, e.g., surface modifiers such as disclosed herein which are attached to the base material, e.g., via derivatization or coating and later crosslinking, imparting the chemical character of the surface modifier to the base material. In an embodiment, such surface modifiers have the formula Zₐ(R′)_{b}Si—R, where Z=Cl, Br, I, C₁-C₅ alkoxy, dialkylamino, e.g., dimethylamino, or trifluoromethanesulfonate; a and b are each an integer from 0 to 3 provided that a+b=3; R′ is a C₁-C₆ straight, cyclic or branched alkyl group, and R is a functionalizing group. R′ may be, e.g., methyl, ethyl, propyl, isopropyl, butyl, t-butyl, sec-butyl, pentyl, isopentyl, hexyl or cyclohexyl; preferably, R′ is methyl.

The porous inorganic/organic hybrid monolith materials possess both organic groups and silanol groups which may additionally be substituted or derivatized with a surface modifier. “Surface modifiers” include (typically) organic groups which impart a certain chromatographic functionality to a chromatographic stationary phase. Surface modifiers such as disclosed herein are attached to the base material, e.g., via derivatization or coating and later crosslinking, imparting the chemical character of the surface modifier to the base material. In one embodiment, the organic groups of the hybrid materials react to form an organic covalent bond with a surface modifier. The modifiers can form an organic covalent bond to the material's organic group via a number of mechanisms well known in organic and polymer chemistry including but not limited to nucleophilic, electrophilic, cycloaddition, free-radical, carbene, nitrene, and carbocation reactions. Organic covalent bonds are defined to involve the formation of a covalent bond between the common elements of organic chemistry including but not limited to hydrogen, boron, carbon, nitrogen, oxygen, silicon, phosphorus, sulfur, and the halogens. In addition, carbon-silicon and carbon-oxygen-silicon bonds are defined as organic covalent bonds, whereas silicon-oxygen-silicon bonds that are not defined as organic covalent bonds. In general, the porous inorganic/organic hybrid monolith materials can be modified by an organic group surface modifier, a silanol group surface modifier, a polymeric coating surface modifier, and combinations of the aforementioned surface modifiers.

For example, silanol groups are surface modified with compounds having the formula Zₐ(R′)_{b}Si—R, where Z=Cl, Br, I, C₁-C₅ alkoxy, dialkylamino, e.g., dimethylamino, or trifluoromethanesulfonate; a and b are each an integer from 0 to 3 provided that a+b=3; R′ is a C₁-C₆ straight, cyclic or branched alkyl group, and R is a functionalizing group. R′ may be, e.g., methyl, ethyl, propyl, isopropyl, butyl, t-butyl, sec-butyl, pentyl, isopentyl, hexyl or cyclohexyl; preferably, R′ is methyl. In certain embodiments, the organic groups may be similarly functionalized.

The functionalizing group R may include alkyl, aryl, cyano, amino, diol, nitro, cation or anion exchange groups, or embedded polar functionalities. Examples of suitable R functionalizing groups include C₁-C₃₀ alkyl, including C₁-C₂₀, such as octyl (C₈), octadecyl (C₁₈), and triacontyl (C₃₀); alkaryl, e.g., C₁-C₄-phenyl; cyanoalkyl groups, e.g., cyanopropyl; diol groups, e.g., propyldiol; amino groups, e.g., aminopropyl; and alkyl or aryl groups with embedded polar functionalities, e.g. carbamate functionalities such as disclosed in U.S. Pat. No. 5,374,755, the text of which is incorporated herein by reference. Such groups include those of the general formula

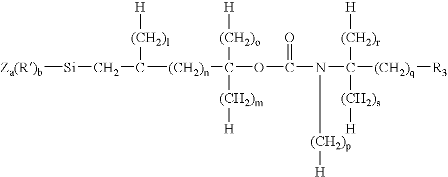

wherein l, m, o, r, and s are 0 or 1, n is 0, 1, 2 or 3 p is 0, 1, 2, 3 or 4 and q is an integer from 0 to 19; R₃ is selected from the group consisting of hydrogen, alkyl, cyano and phenyl; and Z, R′, a and b are defined as above. Preferably, the carbamate functionality has the general structure indicated below:

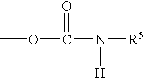

wherein R⁵ may be, e.g., cyanoalkyl, t-butyl, butyl, octyl, dodecyl, tetradecyl, octadecyl, or benzyl. Advantageously, R⁵ is octyl, dodecyl, or octadecyl.

In a preferred embodiment, the surface modifier may be an organotrihalosilane, such as octyltrichlorosilane or octadecyltrichlorosilane. In an additional preferred embodiment, the surface modifier may be a halopolyorganosilane, such as octyldimethylchlorosilane or octadecyldimethylchlorosilane. In certain embodiments the surface modifier is octadecyltrimethoxysilane.

In another embodiment, the hybrid material's organic groups and silanol groups are both surface modified or derivatized. In another embodiment, the hybrid materials are surface modified by coating with a polymer.

A chromatographic stationary phase is said to be “end-capped” when a small silylating agent, such as trimethylchlorosilane, is used to bond residual silanol groups on a packing surface. It is most often used with reversed-phase packings and may cut down on undesirable adsorption of basic or ionic compounds. For example, end-capping occurs when bonded hybrid silica is further reacted with a short-chain silane such as trimethylchlorosilane to end-cap the remaining silanol groups. The goal of end-capping is to remove as many residual silanols as possible. In order of decreasing reactivity, agents that can be used as trimethylsilyl donors for end-capping include trimethylsilylimidazole (TMSIM), bis-N,O-trimethylsilyltrifluoroacetamide (BSTFA), bis-N,O-trimethylsilylacetamide (BSA), trimethylsilyldimethylamine (TMSDMA), trimethylchlorosilane (TMS), and hexamethyldisilane (HMDS). Preferred end-capping reagents include trimethylchlorosilane (TMS), trimethylchlorosilane (TMS) with pyridine, and trimethylsilylimidazole (TMSIM).

“Porogens” are described in Small et al., U.S. Pat. No. 6,027,643. A porogen is an added material which, when removed after the polymerization is complete, increases the porosity of a hybrid monolith. The porosity should be such that it provides for a ready flow of liquids through the polymer phase while at the same time providing adequate areas of contact between the polymer and liquid phase. The porogen can be a solvent which is rejected by the polymer as it forms and is subsequently displaced by another solvent or water. Suitable liquid porogens include an alcohol, e.g., used in the manner described in Analytical Chemistry, Vol. 68, No. 2, pp. 315-321, Jan. 15, 1996. Reverse micellular systems obtained by adding water and suitable surfactant to a polymerizable monomer have been described as porogens by Menger et al., J Am Chem Soc (1990) 112:1263-1264. Other examples of porogens can be founds in Li et al., U.S. Pat. No. 5,168,104 and Mikes et al., U.S. Pat. No. 4,104,209.

The term “surfactant,” as used herein, is intended to include a single surfactant or a combination of two or more surfactants.

“Porosity” is the ratio of the volume of a particle's interstices to the volume of the particle's mass.

“Pore volume” is the total volume of the pores in a porous packing, and is usually expressed in mL/g. It can be measured by the BET method of nitrogen adsorption or by mercury intrusion, where Hg is pumped into the pores under high pressure. As described in Quinn et al. U.S. Pat. No. 5,919,368, “pore volume” can be measured by injecting acetone into beds as a total permeating probe, and subsequently a solution of 6×10⁶ molecular weight polystyrene as a totally excluded probe. The transit or elution time through the bed for each standard can be measured by ultra-violet detection at 254 nm. Percent intrusion can be calculated as the elution volume of each probe less the elution volume of the excluded probe, divided by the pore volume. Alternatively, pore volume can be determined as described in Perego et al. U.S. Pat. No. 5,888,466 by N₂ adsorption/desorption cycles at 77° K, using a Carlo Erba Sorptomatic 1900 apparatus.

As described in Chieng et al. U.S. Pat. No. 5,861,110, “pore diameter” can be calculated from 4V/S BET, from pore volume, or from pore surface area. The pore diameter is important because it allows free diffusion of solute molecules so they can interact with the stationary phase. 60 Å and 100 Å pore diameters are most popular. For packings used for the separation of biomolecules, pore diameters >300 Å are used.

As also described by Chieng et al in U.S. Pat. No. 5,861,110, “particle surface area” can be determined by single point or multiple point BET. For example, multipoint nitrogen sorption measurements can be made on a Micromeritics ASAP 2400 instrument. The specific surface area is then calculated using the multipoint BET method, and the average pore diameter is the most frequent diameter from the log differential pore volume distribution (dV/dlog(D) vs. D Plot). The pore volume is calculated as the single point total pore volume of pores with diameters less than ca. 3000 Å.

The term “aliphatic group” includes organic compounds characterized by straight or branched chains, typically having between 1 and 22 carbon atoms. Aliphatic groups include alkyl groups, alkenyl groups and alkynyl groups. In complex structures, the chains can be branched or cross-linked. Alkyl groups include saturated hydrocarbons having one or more carbon atoms, including straight-chain alkyl groups and branched-chain alkyl groups. Such hydrocarbon moieties may be substituted on one or more carbons with, for example, a halogen, a hydroxyl, a thiol, an amino, an alkoxy, an alkylcarboxy, an alkylthio, or a nitro group. Unless the number of carbons is otherwise specified, “lower aliphatic” as used herein means an aliphatic group, as defined above (e.g., lower alkyl, lower alkenyl, lower alkynyl), but having from one to six carbon atoms. Representative of such lower aliphatic groups, e.g., lower alkyl groups, are methyl, ethyl, n-propyl, isopropyl, 2-chloropropyl, n-butyl, sec-butyl, 2-aminobutyl, isobutyl, tert-butyl, 3-thiopentyl, and the like.

As used herein, the term “nitro” means —NO₂; the term “halogen” designates —F, —Cl, —Br or —I; the term “thiol” means SH; and the term “hydroxyl” means —OH.

The term “alicyclic group” includes closed ring structures of three or more carbon atoms. Alicyclic groups include cycloparaffins which are saturated cyclic hydrocarbons, cycloolefins and naphthalenes which are unsaturated with two or more double bonds, and cycloacetylenes which have a triple bond. They do not include aromatic groups. Examples of cycloparaffins include cyclopropane, cyclohexane, and cyclopentane. Examples of cycloolefins include cyclopentadiene and cyclooctatetraene. Alicyclic groups also include fused ring structures and substituted alicyclic groups such as alkyl substituted alicyclic groups. In the instance of the alicyclics such substituents can further comprise a lower alkyl, a lower alkenyl, a lower alkoxy, a lower alkylthio, a lower alkylamino, a lower alkylcarboxyl, a nitro, a hydroxyl, —CF₃, —CN, or the like.

The term “heterocyclic group” includes closed ring structures in which one or more of the atoms in the ring is an element other than carbon, for example, nitrogen, sulfur, or oxygen. Heterocyclic groups can be saturated or unsaturated and heterocyclic groups such as pyrrole and furan can have aromatic character. They include fused ring structures such as quinoline and isoquinoline. Other examples of heterocyclic groups include pyridine and purine. Heterocyclic groups can also be substituted at one or more constituent atoms with, for example, a halogen, a lower alkyl, a lower alkenyl, a lower alkoxy, a lower alkylthio, a lower alkylamino, a lower alkylcarboxyl, a nitro, a hydroxyl, —CF₃, —CN, or the like. Suitable heteroaromatic and heteroalicyclic groups generally will have 1 to 3 separate or fused rings with 3 to about 8 members per ring and one or more N, O or S atoms, e.g. coumarinyl, quinolinyl, pyridyl, pyrazinyl, pyrimidyl, furyl, pyrrolyl, thienyl, thiazolyl, oxazolyl, imidazolyl, indolyl, benzofuranyl, benzothiazolyl, tetrahydrofuranyl, tetrahydropyranyl, piperidinyl, morpholino and pyrrolidinyl.

The term “aromatic group” includes unsaturated cyclic hydrocarbons containing one or more rings. Aromatic groups include 5- and 6-membered single-ring groups which may include from zero to four heteroatoms, for example, benzene, pyrrole, furan, thiophene, imidazole, oxazole, thiazole, triazole, pyrazole, pyridine, pyrazine, pyridazine and pyrimidine, and the like. The aromatic ring may be substituted at one or more ring positions with, for example, a halogen, a lower alkyl, a lower alkenyl, a lower alkoxy, a lower alkylthio, a lower alkylamino, a lower alkylcarboxyl, a nitro, a hydroxyl, —CF₃, —CN, or the like.

The term “alkyl” includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In preferred embodiments, a straight chain or branched chain alkyl has 20 or fewer carbon atoms in its backbone (e.g., C₁-C₂₀ for straight chain, C₃-C₂₀ for branched chain), and more preferably 12 or fewer. Likewise, preferred cycloalkyls have from 4-10 carbon atoms in their ring structure, and more preferably have 4-7 carbon atoms in the ring structure. The term “lower alkyl” refers to alkyl groups having from 1 to 6 carbons in the chain, and to cycloalkyls having from 3 to 6 carbons in the ring structure.

Moreover, the term “alkyl” (including “lower alkyl”) as used throughout the specification and claims includes both “unsubstituted alkyls” and “substituted alkyls”, the latter of which refers to alkyl moieties having substituents replacing a hydrogen on one or more carbons of the hydrocarbon backbone. Such substituents can include, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, stulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety. It will be understood by those skilled in the art that the moieties substituted on the hydrocarbon chain can themselves be substituted, if appropriate. Cycloalkyls can be further substituted, e.g., with the substituents described above. An “aralkyl” moiety is an alkyl substituted with an aryl, e.g., having 1 to 3 separate or fused rings and from 6 to about 18 carbon ring atoms, (e.g., phenylmethyl (benzyl)).

The term “alkylamino” as used herein means an alkyl group, as defined herein, having an amino group attached thereto. Suitable alkylamino groups include groups having 1 to about 12 carbon atoms, preferably from 1 to about 6 carbon atoms. The term “alkylthio” refers to an alkyl group, as defined above, having a sulfhydryl group attached thereto. Suitable alkylthio groups include groups having 1 to about 12 carbon atoms, preferably from 1 to about 6 carbon atoms. The term “alkylcarboxyl” as used herein means an alkyl group, as defined above, having a carboxyl group attached thereto. The term “alkoxy” as Used herein means an alkyl group, as defined above, having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like. The terms “alkenyl” and “alkynyl” refer to unsaturated aliphatic groups analogous to alkyls, but which contain at least one double or triple bond respectively. Suitable alkenyl and alkynyl groups include groups having 2 to about 12 carbon atoms, preferably from 1 to about 6 carbon atoms.

The term “aryl” includes 5- and 6-membered single-ring aromatic groups that may include from zero to four heteroatoms, for example, unsubstituted or substituted benzene, pyrrole, furan, thiophene, imidazole, oxazole, thiazole, triazole, pyrazole, pyridine, pyrazine, pyridazine and pyrimidine, and the like. Aryl groups also include polycyclic fused aromatic groups such as naphthyl, quinolyl, indolyl, and the like. The aromatic ring can be substituted at one or more ring positions with such substituents, e.g., as described above for alkyl groups. Suitable aryl groups include unsubstituted and substituted phenyl groups. The term “aryloxy” as used herein means an aryl group, as defined above, having an oxygen atom attached thereto. The term “aralkoxy” as used herein means an aralkyl group, as defined above, having an oxygen atom attached thereto. Suitable aralkoxy groups have 1 to 3 separate or fused rings and from 6 to about 18 carbon ring atoms, e.g., O-benzyl.

The term “amino,” as used herein, refers to an unsubstituted or substituted moiety of the formula —NRₐR_{b}, in which Rₐ and R_{b} are each independently hydrogen, alkyl, aryl, or heterocyclyl, or Rₐ and R_{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. An “amino-substituted amino group” refers to an amino group in which at least one of Rₐ and R_{b}, is further substituted with an amino group.

### COMPOSITION AND METHODS OF THE INVENTION

The invention provides hybrid monolith materials for performing separations, e.g., chromatographic separations, or for participating in chemical reactions. The monoliths in accordance with the invention have an interior area and an exterior surface, and are represented by Formula I as set forth below:
[A]_{y}[B]ₓ (Formula I)

where x and y are whole number integers and A is represented by Formula II and/or Formula III below:
SiO_{2/}(R¹ₚR²_{q}SiOₜ)ₙ (Formula II), and/or SiO₂/[R³(R¹ᵣSiOₜ)ₘ]ₙ (Formula III);

where R¹ and R² are independently a substituted or unsubstituted C₁ to C₇ alkyl group or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2; and n is a number from 0.01 to 100; B is represented by Formula IV below:
SiO₂/(R⁴ᵥSiOₜ)ₙ (Formula IV)

where R⁴ is selected from the group consisting of hydroxyl, fluorine, alkoxy (e.g. methoxy), aryloxy, substituted siloxane, protein, peptide, carbohydrate, nucleic acid, and combinations thereof, and R⁴ is nor R¹, R², or R³; v is 1 or 2, provided that when v=1, t=1.5, and when v=2, t=1; and n is a number from 0.01 to 100; said interior of said particle having a composition of A, said exterior surface of said monolith having a composition represented by A and B, and where said exterior composition is between about 1 and about 99% of the composition of B and the remainder including A. In the above formula, R⁴ may be represented by:
—OSi(R⁵)₂—R⁶ (Formula V)

where R⁵ is selected from a group consisting of a C₁ to C₆ straight, cyclic, or branched alkyl, aryl, or alkoxy group, a hydroxyl group, or a siloxane group, and R⁶ is selected from a group consisting of a C₁ to C₃₆ straight, cyclic, or branched alkyl (e.g. C₁₈, cyanopropyl), aryl, or alkoxy group, where the said groups of R⁶ are unsubstituted or substituted with one or more moieties selected from the group consisting of halogen, cyano, amino, diol, nitro, ether, carbonyl, epoxide, sulfonyl, cation exchanger, anion exchanger, carbamate, amide, urea, peptide, protein, carbohydrate, and nucleic acid functionalities.

In general, the hybrid monoliths of the invention possess higher pore volumes and surface areas as compared to corresponding hybrid particles. For example, in certain embodiments, the hybrid monoliths of the invention have specific pore volumes of about 0.5 to about 2.5 cm³/g. In other embodiments, the hybrid monoliths of the invention have specific pore volumes of about 1 to about 2 cm³/g. Likewise, in certain embodiments, the hybrid monoliths of the invention have specific surface areas of about 50 to about 800 m²/g. In other embodiments, the hybrid monoliths of the invention have specific surface areas of about 190 to about 520 m²/g.

In an embodiment, the surface concentration R⁶ may be greater than about 1.0 μmol/m², more preferably greater than about 2.0 μmol/m², and still more preferably greater than about 3.0 μmol/m². In a preferred embodiment, the surface concentration of R⁶ is between about 1.0 and about 3.4 μmol/m².

The porous inorganic/organic hybrid monolith materials of the invention may have a surface concentration of silicon-methyl groups that is less than about 2.5 μmol/m².

The porous inorganic/organic hybrid monolith materials of the invention may have a surface concentration of the bonded phase alkyl groups that is greater than about 1.0 μmol/m².

The surface concentration of silicon-methyl groups may be less than about 2.5 μmol/m², preferably between about 0.1 and about 2.5 μmol/m², more preferably between about 0.25 and about 2.5 μmol/m². The surface concentration of the bonded phase alkyl groups is generally greater than about 1.0 μmol/m², more preferably greater than about 3.0 μmol/m², still more preferably between about 1.0 and about 3.4 μmol/m².

The hybrid material may have a bonded phase such as C₁₈, C₈, cyanopropyl, or 3-cyanopropyl.

In an embodiment, the hybrid monolith materials have an average pore diameter of between about 35 and about 500 Å, more preferably between about 100 and about 300 Å. The above hybrid materials have increased stability at low pH (e.g., below 4, below 3, below 2). In a method of performing high performance liquid chromatography a sample at a pH below 3, below 4, or below 5 may be run through a column containing one of the above hybrid materials.

In certain embodiments, the porous inorganic/organic hybrid monoliths of the invention have a chromatographically enhancing pore geometry. Such monoliths are described in WO 03/014450.

Porous inorganic/organic hybrid monolith materials may be made as described below and in the specific instances illustrated in the Examples. In particular, the hybrid monolith materials of the current invention may be indirectly prepared by coalescing inorganic/organic hybrid particles or may be directly prepared from inorganic and organic precursors.

In accordance with the indirect method, porous spherical particles of hybrid silica may, in one embodiment, be prepared by a multi-step process. In the first step, one or more organoalkoxysilanes such as methyltriethoxysilane, and a tetraalkoxysilane such as tetraethoxysilane (TEOS) are prepolymerized to form a polyorganoalkoxysiloxane (POS), e.g., polyalkylalkoxysiloxane, by co-hydrolyzing a mixture of the two or more components in the presence of an acid catalyst. In the second step, the POS is suspended in an aqueous medium in the presence of a surfactant or a combination of surfactants and gelled into porous spherical particles of hybrid silica using a base catalyst. In the third step, the pore structure of the hybrid silica particles is modified by hydrothermal treatment, producing an intermediate hybrid silica product which may be used for particular purposes itself, or desirably may be further processed, as described below.

The porous particles of hybrid silica may be used as prepared by the process noted above, without further modification. These hybrid particles are mixed with a second material, e.g., unbonded silica, and packed into a container, e.g., a column. After packing is complete, the mixture is coalesced, e.g., sintered, and the second material is subsequently removed by a washing step. The resulting monolith material is further processed, e.g., rinsed with a solvent, to result in the hybrid monolith material.

Alternatively, the monolith materials may be directly prepared from inorganic and organic precursors. An example of a direct preparation method is a sol-gel process. Current sol-gel processes for inorganic monolith materials require a calcination step where the temperature reaches above 400° C. This process is not suitable for hybrid monolith materials because the organic moieties can be destroyed. Furthermore, silanol groups can be irreversibly condensed above 400° C., leaving behind more acidic silanols. As a result, some analytes, particularly basic analytes, can suffer from increased retention, excessive tailing and irreversible adsorption. The sol-gel process of the current invention of preparing the inorganic/organic hybrid monolith materials at low temperature preserves the organic moieties in the monolith material and precludes irreversible silanol condensation.

The general process for directly preparing an inorganic/organic hybrid monolith material in a single step from inorganic and organic precursors can be characterized by the following process.

First, a solution is prepared containing an aqueous acid, e.g., acetic, with a surfactant, an inorganic precursor, e.g., a tetraalkoxysilane, and an organic precursor, e.g., a organoalkoxysilane, e.g., organotrialkoxysilane. The range of acid concentration is from about 0.1 mM to 500 mM, more preferably from about 10 mM to 150 mM, and still more preferably from about 50 mM to 120 mM. The range of surfactant concentration is between about 3% and 15% by weight, more preferably between about 7 and 12% by weight, and still more preferably between about 8% to 10% by weight. Furthermore, the range of the total silane concentration, e.g., methyltrimethoxysilane and tetramethoxysilane, employed in the process is kept below about 5 g/ml, more preferably below 2 g/ml, and still more preferably below 1 g/ml.

The sol solution is then incubated at a controlled temperature, resulting in a three-dimensional gel having a continuous, interconnected pore structure. The incubation temperature range is between about the freezing point of the solution and 90° C., more preferably between about 20° C. and 70° C., still more preferably between about 35° C. and 60° C. The gel is aged at a controlled pH, preferably about pH 2-3, and temperature, preferably about 20-70° C., more preferably about 35 to 60° C., for about 5 hours to about 10 days, more preferably from about 10 hours to about 7 days, and still more preferably from about 2 days to about 5 days, to yield a solid monolith material.

In order to further gel the hybrid material and to remove surfactant, the monolith material is rinsed with an aqueous basic solution, e.g., ammonium hydroxide, at an temperature of about 0° C. to 80° C., more preferably between about 20° C. and 70° C., and still more preferably between about 40° C. and 60° C. Additionally, in certain embodiments, the concentration of base is between about 10⁻⁵ N and 1 N, more preferably between about 10⁻⁴ N and 0.5 N, and still more preferably between about 10⁻³ N and 0.1 N. The monolith material is rinsed for about 1 to 6 days, more preferably for about 1.5 to 4.5 days, and still more preferably for about 2 to 3 days.

In an embodiment, the pore structure of the as-prepared hybrid material is modified by hydrothermal treatment, which enlarges the openings of the pores as well as the pore diameters, as confirmed by BET nitrogen (N₂) sorption analysis. The hydrothermal treatment is performed by preparing a slurry containing the as-prepared hybrid material and a solution of organic base in water, heating the slurry in an autoclave at an elevated temperature, e.g., about 143 to 168° C., for a period of about 6 to 28 h. The pH of the slurry is adjusted to be in the range of about 8.0 to 9.0 using concentrated acetic acid. The concentration of the slurry is in the range of 1 g hybrid material per 4 to 10 ml of the base solution. The thus-treated hybrid material is filtered, and washed with water and acetone until the pH of the filtrate reaches 7, then dried at 100° C. under reduced pressure for 16 h. The resultant hybrid materials show average pore diameters in the range of about 100-300 Å.

For attaching proteins or peptides to the surface of a silica monolith material, the monolith may be treated with an aldehyde-containing silane reagent. MacBeath, et al. (2000) Science 289:1760-1763. Aldehydes react readily with primary amines on the proteins to form a Schiff base linkage. The aldehydes may further react with lysines. Alternatively, proteins, peptides, and other target molecules may be attached to the surface of the silica monolith by using N-{m-{3-(trifluoromethyl)diazirin-3-yl}phenyl}-4-maleimidobutyramide which carries a maleimide function for thermochemical modification of cysteine thiols and an aryldiazirine function for light-dependent, carbene mediated binding to silica monoliths. Collioud, et al. (1993) Bioconjugate 4:528-536. Activation of a carbene-generating aryldiazirine with a 350-nm light source has been shown to lead to covalent coupling of proteins, enzymes, immunoreagents, carbohydrates, and nucleic acids under conditions such that biological activity is not impaired. Proteins or peptides can also be attached to the surface of a silica monolith by derivatizing the surface silanol groups of the silica monolith with 3-aminopropyl-triethoxysilane (APTS), 3-NH₂(CH₂)₃Si(OCH₂CH₃)₃. Han, et al. (1999) J. Am. Chem. Soc. 121:9897-9898.

In an example of binding a carbohydrate to the surface of a silica monolith material, an octagalactose derivative of calix{4}resorcarene is obtained by the reaction of lactonolactone with octaamine. Fujimoto, et al. (1997) J. Am. Chem. Soc. 119:6676-6677. When a silica-monolith material is dipped into an aqueous solution of the octagalactose derivative, the resulting octagalactose derivative is readily adsorbed on the surface of the silicamonolith material. The interaction between the octagalactose derivative and the silica monolith material involves hydrogen bonds. Ho Chang, et al., U.S. Pat. No. 4,029,583 describes the use of a silane coupling agent that is an organosilane with a silicon functional group capable of bonding to a silica monolith material and an organic functional group capable of bonding to a carbohydrate moiety.

For bonding oligonucleotides to the surface of a silica monolith material, the silica monolith material may be treated with APTS to generate aminosilane-modified monolith materials. The aminosilane-modified monolith materials are then treated with p-nitrophenylchloroformate (NPC) (Fluka), glutaraldehyde (GA) (Sigma), maleic anhydride (MA) (Aldrich) and then treated with 5′-NH₂-labeled DNA or 5′-SH-labeled DNA. Yang, et al. (1998) Chemistry Letters, pp. 257-258. Alternatively, oligonucleotides can be added to the surface of a silica monolith material by reacting 3-glyciodoxypropyltrimethoxysilane with a silica monolith material bearing silanol groups and then cleaving the resulting epoxide with a diol or water under acidic conditions. Maskos, et al. (1992) Nucleic Acids Research 20(7):1679-1684. Oligonucleotides can also bind to the surface of a silica monolith material via a phosphoramidate linkage to a silica monolith material containing amine functionalities. For example, silica monolith material containing an amine functionality was reacted with a 5′-phorimidazolide derivative. Ghosh, et al. (1987) Nucleic Acids Research 15(13):5353-5373. A 5′-phosphorylated oligonucleotide was reacted with the amine groups in the presence of water soluble 1-ethyl-3-(3-dimethylaminopropyl)-carbodiimide (EDC) in N-methylimidazole buffer. Light directed chemical synthesis can be used to attach oligonucleotides to the surface of a silica monolith material. To begin the process, linkers modified with photochemically removable protecting groups are attached to a solid substrate. Light is directed through a photolithographic mask to specific areas of the surface, activating those areas for chemical coupling. Lipshutz, et al. (1993) BioTechniques 19(3):442-447.

The surface of hybrid silica prepared so far still contains silanol groups, which can be derivatized by reacting with a reactive organosilane. The surface derivatization of the hybrid silica is conducted according to standard methods, for example by reaction with octadecyldimethylchlorosilane in an organic solvent under reflux conditions. An organic solvent such as toluene is typically used for this reaction. An organic base such as pyridine or imidazole is added to the reaction mixture to catalyze the reaction. The thus-obtained product is then washed with water, toluene and acetone and dried at 100° C. under reduced pressure for 16 h. The resultant hybrid silica can be further reacted with a short-chain silane such as trimethylchlorosilane to end-cap the remaining silanol groups, by using a similar procedure described above.

The surface of the hybrid silica monolith materials may also be surface modified with a surface modifier, e.g., Zₐ(R′)_{b}Si—R, where Z=Cl, Br, I, C₁-C₅ alkoxy, dialkylamino, e.g., dimethylamino or trifluoromethanesulfonate; a and b are each an integer from 0 to 3 provided that a+b=3; R′ is a C₁-C₆ straight, cyclic or branched alkyl group, and R is a functionalizing group, and by polymer coating. R′ may be, e.g., methyl, ethyl, propyl, isopropyl, butyl, t-butyl, sec-butyl, pentyl, isopentyl, hexyl or cyclohexyl; preferably, R′ is methyl.

The functionalizing group R may include alkyl, aryl, cyano, amino, diol, nitro, cation or anion exchange groups, or embedded polar functionalities. Examples of suitable R functionalizing groups include C₁-C₂₀ alkyl such as octyl (C₈) and octadecyl (C₁₈); alkaryl, e.g., C₁-C₄-phenyl; cyanoalkyl groups, e.g., cyanopropyl; diol groups, e.g., propyldiol; amino groups, e.g., aminopropyl; and embedded polar functionalities, e.g., carbamate functionalities such as disclosed in U.S. Pat. No. 5,374,755 and as detailed hereinabove. In a preferred embodiment, the surface modifier may be a haloorganosilane, such as octyldimethylchlorosilane or octadecyldimethylchlorosilane. Advantageously, R is octyl or octadecyl.

Polymer coatings are known in the literature and may be provided generally by polymerization or polycondensation of physisorbed monomers onto the surface without chemical bonding of the polymer layer to the support (type I), polymerization or polycondensation of physisorbed monomers onto the surface with chemical bonding of the polymer layer to the support (type II), immobilization of physisorbed prepolymers to the support (type III), and chemisorption of presynthesized polymers onto the surface of the support (type IV). see, e.g., Hanson et al., J. Chromat. A656 (1993) 369-380.

In the current state of the art, hybrid organic/inorganic based RP HPLC column packing is prepared by bonding chlorosilanes to a hybrid monolith material. The hybrid monolith material has a methyl-silicon group incorporated throughout the monolith's structure, that is, the methyl group is found in both the internal framework of the hybrid silicate backbone as well as on the monolith's external surface. Both the internal and external methyl groups have been shown to contribute to the hybrid's improved stability in high pH mobile phases when compared to purely silica based materials. However, the surface methyl groups also lead to lower bonded phase surface concentrations after bonding with silanes, e.g., C₁₈ and C₈ silanes, in comparison to silica phases, presumably because the methyl groups on the surface are unreactive to bonding. For example, when using low pH (e.g., about pH 5) mobile phases, a hybrid product such as XTerra™ MS C₁₈, which has a trifunctional C₁₈ bonded phase, is less stable compared to conventional silica based trifunctional C₁₈ bonded phases. The surface methyl groups of the hybrid monolith may decrease the level of cross-bonding between adjacent C₁₈ ligands, essentially the methyl groups block the connection. This effect would be expected to reduce low pH stability, since the C₁₈ ligand has fewer covalent bonds to the surface.

The present invention provides a procedure to selectively convert surface silicon-methyl groups with silanol groups. Depending on the reaction conditions, the monolith's internal framework is not disturbed or is only slightly disturbed leaving the internal methyl groups unaffected. This then results in a monolith different from the original hybrid monolith, where the surface now more resembles that of pure silica. The monolith's new composition is supported by standard analytical analysis (CHN, BET, NMR).

These modified monoliths have also been found to afford a high C₁₈ surface concentration after bonding with chlorosilanes, arguably due to the newly formed surface silanols being converted to ligand siloxanes.

Conversion of Surface Si—CH₃ Groups into Si—OH and Si—F Groups
Si—CH₃ groups at the surface of the hybrid monolith can be converted into Si—OH and Si—F groups by the following reaction

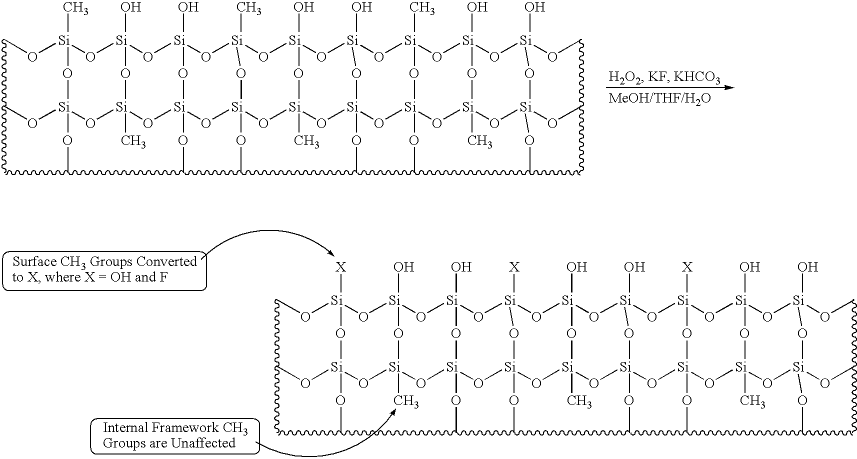

The above reaction is run in methanol/THF/water, so full wetting and total pore access should be possible. The mechanism of cleavage appears to be a modified Baeyer-Villager oxidation, which should have a minimal transition state requirement. Methyl loss may be measured by e.g. CHN combustion analysis of the reacted product, where the reduction in % C of reacted versus untreated is taken as a measure of surface methyl groups lost and hence present on the surface. IR and NMR analysis could also be used to measure this change as well as look for any other surface changes.

Other fluorinating reagents can be used in place of KF. For example, potassium hydrogen fluoride (KHF₂), tetrabutylammonium fluoride ({CH₃CH₂CH₂CH₂}₄NF), boron trifluoride-acetic acid complex (BF₃—2{CH₃CO₂H}), or boron hydrogen tetrafluoride diethyl etherate (HBF₄—O(CH₂CH₃)₂) can be used in place of KF.

Other carbonate reagents, such as sodium hydrogencarbonate, for example, can be used in place of potassium hydrogencarbonate.

Other reagents can be used in place of hydrogen peroxide (H₂O₂). For example, 3-chloroperoxybenzoic acid (ClC₆H₄CO₃H) and peracetic acid (CH₃CO₃H) can be used in place of hydrogen peroxide (H₂O₂).

Alternatively, silicon-carbon bonds can be cleaved by reacting the silicon compound with m-chloroperbenzoic acid (MCPBA) as shown below. A description of this synthesis can be found in Tamao, et al. (1982) Tetrahedron 39(6):983-990.

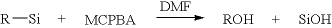

Similarly, silicon-carbon bonds can be cleaved by reacting the silicon compound with hydrogen peroxide as shown below. A description of this synthesis can be found in Tamao, et al. (1983) Organometallics 2:1694-1696.

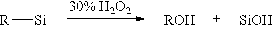

The porous inorganic/organic hybrid monolith materials of the current invention have a wide variety of end uses in the separation sciences, such as materials for chromatographic columns (wherein such columns may have improved stability to alkaline mobile phases and reduced peak tailing for basic analytes), thin layer chromatographic (TLC) plates, filtration membranes, microtiter plates, scavenger resins, solid phase organic synthesis supports, and the like, having a stationary phase that includes porous inorganic/organic hybrid materials having a chromatographically-enhancing pore geometry and porous inorganic/organic hybrid monolith materials of the present invention. The stationary phase may be introduced by packing, coating, impregnation, cladding, wrapping, or other art-recognized techniques, etc., depending on the requirements of the particular device. In a particularly advantageous embodiment, the chromatographic device is a chromatographic column, such as commonly used in HPLC.

### EXAMPLES

The present invention may be further illustrated by the following non-limiting examples describing the preparation of porous inorganic/organic hybrid monolith materials.

Materials

All reagents were used as received unless otherwise noted. Those skilled in the art will recognize that equivalents of the following supplies and suppliers exist, and as such the suppliers listed below are not to be construed as limiting.

Gelest Inc., Morrisville, Pa.: (3-Methacryloxypropyl)trimethoxysilane (MAPTMOS), tetramethoxysilane (TMOS), methyltrimethoxysilane (MTMOS), bis(trimethoxysilyl)-ethane (BTME) and octadecyldimethylchlorosilane (ODS); BASF Corp., Mount Olive, N.J.: Pluronic® P105, Pluronic® P123; Aldrich Chemical, Milwaukee, Wis.: imidazole, Triton X-100 tris(hydroxymethyl)aminomethane (TRIS), potassium fluoride (KF), potassium hydrogencarbonate (KHCO₃), 30% hydrogen peroxide (30% H₂O₂), tetramethoxysilane (TMOS), octadecyldimethylchlorosilane; J. T. Baker, Phillipsburgh, N.J.: urea, methylene chloride, methanol, tetrahydrofuran (THF), acetonitrile, acetone, toluene, pyridine, hydrochloride acid, aqueous ammonia, and glacial acetic acid. All solvents were HPLC grade. Water was used directly from a Millipore Milli-Q (Millipore Corp., Bedford, Mass.). The pressure autoclave was from Parr Instruments, Inc., Moline, Ill.

Characterization

Those skilled in the art will recognize that equivalents of the following instruments and suppliers exist, and as such the instruments listed below are not to be construed as limiting.

The median macropore diameter (MPD) and macropore pore volume (MPV) were measured by Mercury Porosimetry (Micromeritics AutoPore II 9220 or AutoPore IV, Micromeritics, Norcross, Ga.). The % C values of these materials were measured by combustion analysis (CE-440 Elemental Analyzer; Exeter Analytical Inc., North Chelmsford, Mass.). Fluorine content (F) was measured by the combustion/ISE method by Galbraith Laboratories, Inc., Knoxville, Tenn. The specific surface areas (SSA), specific pore volumes (SPV) and the average pore diameters (APD) of these materials were measured using the multi-point N₂ sorption method (Micromeritics ASAP 2400; Micromeritics Instruments Inc., Norcross, Ga.). The specific surface area was calculated using the BET method, the specific pore volume was the single point value determined for P/P₀>0.98, and the average pore diameter was calculated from the desorption leg of the isotherm using the BJH method.

### Example 1

Pluronic P-105, 21.0 g, was dissolved in 150 mL of a 70 mM acetic acid solution. The resulting solution was agitated at room temperature until all of the Pluronic P-105 was dissolved and was then chilled in an ice-water bath. Meanwhile, methyltrimethoxy-silane (20 mL) and tetramethoxysilane (40 mL) were mixed at room temperature in a separate, sealed flask. The mixed silane solution was slowly added into the chilled acetic acid solution, whereupon the silanes dissolved into the acetic acid solution after a few minutes. The resulting solution was transferred into a series of sealed polypropylene vials (9.6 mm×10 cm), and the vials were kept at 45° C. undisturbed for 2 days. The solid white rods produced were subsequently immersed into a solution of 0.1 N aqueous ammonium hydroxide solution for 3 days at 60° C. The monolith rods were then rinsed with water for 2 days, where the water was replaced every 2 hours for an 8 hour daytime period and then allowed to sit overnight. The wet rods (20 Ea) were then immersed in a 150 ml volume of 0.1 M TRIS (pH adjusted to 7.9 with acetic acid) and then heated under pressure in an autoclave at 155° C. for 21 hours. Upon cooling, the monolith rods were immersed in water for 2 days, where the water was replaced every 2 hours for an 8 hour daytime period and then allowed to sit overnight. The water wet rods were then immersed in acetone overnight at 60° C. and finally dried under vacuum at 80° C. for 4 hours. The dried rods (20 Ea) were then immersed in a 2000 mL volume of 1 N HCl solution and heated to 98° C. for 17 hours. Upon cooling, the monolith rods were then washed with water until the effluent was at a pH of 7.0. The water wet rods were washed with acetone and finally dried under vacuum (<30″ Hg) at 70° C. overnight. Example 1b rods were stored for 10 months in water at room temperature prior to treatment with TRIS solution and subsequent acid washing. Characterization data is compiled in Table 1 for a representative rod.

TABLE 1

| | MPD | MPV | | F | SSA | SPV | APD |
|---|---|---|---|---|---|---|---|
| Example | (μm) | (cm³/g) | % C | (ppm) | (m²/g) | (cm³/g) | (Å) |
| 1a | 4.65 | 3.60 | 6.94 | 45 | 476 | 1.64 | 128 |
| 1b | 4.52 | 2.05 | 7.16 | — | 475 | 1.65 | 127 |

### Example 2

Pluronic P-123, 21.0 g, was dissolved in 150 mL of a 100 mM acetic acid solution. The resulting solution was agitated at room temperature until all of the Pluronic P-123 was dissolved and was then chilled in an ice-water bath. Meanwhile, bis(trimethoxysilyl)ethane (20 mL) and tetramethoxysilane (50 mL), were mixed at room temperature in a separate, sealed flask. A 60 mL portion of the mixed silane solution was slowly added into the chilled acetic acid solution, whereupon the silanes dissolved into the acetic acid solution over 30 minutes. The resulting solution was transferred into a series of sealed polypropylene vials (9.6 mm×10 cm), and the vials were kept at room temperature undisturbed for 30 hours. The solid white rods produced were subsequently immersed into a solution of 0.1 N aqueous ammonium hydroxide solution for 3 days at 60° C. The solid white rods was subsequently immersed into a second solution of 0.1 N aqueous ammonium hydroxide solution for 16 hours at 90° C. The monolith rods were then immersed in water and heated to 100° C. for 1 hour, where this process was repeated two additional times. The wet rods (10 Ea) were then immersed in a 250 ml volume of 0.3 M TRIS (pH adjusted to 9.5 with acetic acid) and then heated under pressure in an autoclave at 155° C. for 17 hours. Upon cooling, the monolith rods were immersed with water three times, where the water was replaced every 2 hours. The water wet rods were then immersed in a 2000 mL volume of 1 N HCl solution and heated to 100° C. for 16 hours. Upon cooling, the monolith rods were then washed with water until the effluent was at a pH of 7.0. The water wet rods were washed with acetone and finally dried under vacuum (<30″ Hg) at 70° C. overnight. Example 2b rods were stored for 10 months in water at room temperature prior to treatment with TRIS solution and subsequent acid washing. Characterization data is compiled in Table 2 for representative rods.

TABLE 2

| | MPD | MPV | | F | SSA | SPV | APD |
|---|---|---|---|---|---|---|---|
| Example | (μm) | (cm³/g) | % C | (ppm) | (m²/g) | (cm³/g) | (Å) |
| 2a | — | — | 6.77 | — | 181 | 1.54 | 253 |
| 2b | — | — | 7.07 | — | 181 | 1.64 | 263 |

### Example 3

Triton X-100, 25.0 g, was dissolved in 100 mL of a 15 mM acetic acid solution. The resulting solution was agitated at room temperature until all of the Triton X-100 was dissolved and was then chilled in an ice-water bath. Meanwhile, (3-methacryloxypropyl)trimethoxysilane (10 mL) and tetramethoxysilane (40 mL), were mixed at room temperature in a separate, sealed flask. A 40 mL portion of the mixed silane solution was slowly added into the chilled acetic acid solution, whereupon the silanes dissolved into the acetic acid solution over 60 minutes. The resulting solution was transferred into a series of sealed polypropylene vials (9.6 mm×10 cm). The vials were kept at room temperature undisturbed for 1 hour at room temperature and then were heated to 45° C. for 90 hours. The solid white rods produced were subsequently immersed into a solution of 0.1 N aqueous ammonium hydroxide solution for 1 day at 60° C. The monolith rods were then immersed in water at room temperature for 3 hours, where this process was repeated two additional times and then stored a final time overnight. The wet rods (10 Ea) were then immersed in a 150 ml volume of 0.3 M TRIS (pH adjusted to 9.5 with acetic acid) and then heated under pressure in an autoclave at 155° C. for 18 hours. Upon cooling, the monolith rods were immersed in water for 1 day, where the water was replaced every 2 hours for an 8 hour daytime period and then allowed to sit overnight. The water wet rods were then immersed in acetone overnight at 60° C. and finally dried under vacuum at 80° C. for 4 hours. The dried rods (10 Ea) were then immersed in a 2000 mL volume of 1 N HCl solution and heated to 98° C. for 17 hours. Upon cooling, the monolith rods were then washed with water until the effluent was at a pH of 7.0. The water wet rods were washed with acetone and finally dried under vacuum (30″ Hg) at 70° C. overnight. Characterization data is compiled in Table 3 for a representative rod.

TABLE 3

| | MPD | MPV | | F | SSA | SPV | APD |
|---|---|---|---|---|---|---|---|
| Example | (μm) | (cm³/g) | % C | (ppm) | (m²/g) | (cm³/g) | (Å) |
| 3 | 5.22 | 4.22 | 12.30 | 21 | 540 | 0.97 | 61 |

### Example 4

Monolith rods selected from Example 1, typically 3-5 in number, were immersed in a mixture of methanol (MeOH) and tetrahydrofuran (THF). The type and weight of the combined rods are listed in Table 4. Care was taken to keep the rods separated in from each other and the magnetic stirring bar in order to avoid monolith breakage. Next, potassium fluoride (KF), potassium hydrogencarbonate (KHCO₃), and a 30% H₂O₂ water solution were added, where prescribed amounts are listed in Table 4. The mixture was heated to 60° C. for a prescribed time period as listed in Table 2. Upon cooling, the rods were washed with a copious amount of water and then heated in 800 mL of 1 M HCl solution for 16 hours at 98-100° C. Upon cooling, the rods were washed with a copious amount of water until the pH of the effluent was neutral. The water wet rods were washed with acetone and finally dried under vacuum (<30″ Hg) at 70° C. overnight. Characterization data is compiled in Table 5 for a representative rod.

### Example 5

Monolith rods selected from Example 2, typically 3-5 in number, were treated as described in Example 4. The type and weight of the combined rods as well as reagent amounts are listed in Table 4. Characterization data is compiled in Table 5 for a representative rod.

### Example 6

Monolith rods from Example 3, 3-5 in number, were treated as described in Example 4. The type and weight of the combined rods as well as reagent amounts are listed in Table 4. Characterization data is compiled in Table 5 for a representative rod.

TABLE 4

| | Monolith | Monolith | | | 30% | | | Reaction |
|---|---|---|---|---|---|---|---|---|
| | Starting | Wt. | KF | KHCO₃ | H₂O₂ | THF | MeOH | Time |
| Example | Material | (g) | (g) | (g) | (mL) | (mL) | (mL) | (h) |
| 4a | 1a | 2.5 | 0.60 | 1.03 | 1.79 | 400 | 400 | 3 |
| 4b | 1a | 2.0 | 1.19 | 2.05 | 3.55 | 400 | 400 | 6 |
| 4c | 1b | 3.2 | 0.60 | 1.03 | 1.79 | 800 | 800 | 16 |
| 5a | 2a | 2.0 | 0.42 | 0.71 | 2.40 | 400 | 400 | 3 |
| 5b | 2a | 2.0 | 0.45 | 0.80 | 1.40 | 400 | 400 | 6 |
| 5c | 2b | 4.5 | 0.46 | 0.71 | 2.40 | 800 | 800 | 24 |
| 6 | 3 | 2.0 | 0.67 | 1.16 | 2.0 | 400 | 400 | 3 |

TABLE 5

| | MPD | MPV | | F | SSA | SPV | APD |
|---|---|---|---|---|---|---|---|
| Product | (μm) | (cc/g) | % C | (ppm) | (m²/g) | (cc/g) | (Å) |
| 4a | 4.86 | 3.84 | 6.49 | 363 | 494 | 1.77 | 133 |
| 4b | 4.52 | 3.76 | 6.08 | 44 | 505 | 1.82 | 136 |
| 4c | 4.36 | 4.22 | 5.92 | — | 517 | 1.86 | 134 |
| 5a | 6.78 | 1.82 | 5.56 | 47 | 194 | 1.59 | 250 |
| 5b | 5.09 | 1.28 | 4.36 | 24 | 211 | 1.80 | 270 |
| 5c | — | — | 4.20 | — | 198 | 1.74 | 266 |
| 6a | — | — | 7.07 | 68 | 620 | 1.25 | 68 |

### Example 7

Monolith rods selected from Examples 1 and 4 typically 3-5 in number, were dried thoroughly in 1500 mL of toluene by refluxing for 60 min. Upon cooling to less than 40° C., 5.6 g imidazole and 23.6 g chlorodimethyloctadecylsilane were added, and then the toluene was heated to reflux for 3 hours. Care was taken to keep the rods separated in from each other and suspended above the magnetic stirring bar in order to avoid monolith breakage. Upon cooling to room temperature, the solution was separated from the rods, and the rods were washed with a 100 mL of toluene (3×), acetone (2×), 1:1 v/v acetone:water (3×), and acetone (2×). The acetone wet rods were then suspended in 1500 mL of a 8:2 v/v solution of acetone: 1 M HCl, which was then and heated at 60° C. for 16-24 hours. Upon cooling to room temperature, the solution was separated from the rods, and the rods were washed with a 100 mL of 1:1 v/v acetone:water (2×), acetone (2×), toluene heated to >70° C. (2×), and acetone (2×). The acetone wet rods were dried under vacuum (<30″ Hg) at 70° C. overnight.

For rods 7a-c, a nitrogen containing reactant or side-product was found by combustion analysis in the rods, and a secondary wash step was employed: single rods were suspended in refluxing toluene for 1 hour, and then the toluene was separated from the rods by decantation while the toluene temperature was kept above 90° C. The process was repeated two times for toluene. The process was repeated a fourth time except acetone was used and the decantation temperature minimum was 40° C. The acetone wet rods were then dried under vacuum (<30″ Hg) at 70° C. overnight. In the event nitrogen containing reactants or side-products were still found by combustion analysis in the rods, a secondary wash protocol was repeated.

In an alternative secondary wash process, a 1:1 v/v mixture of acetone:water could be used with heating to about 60° C. following the steps for toluene described above. Characterization data is compiled in Table 6 for representative rods.

### Example 8

Monolith rods selected from Examples 2 and 5 typically 3-5 in number, were treated as described in Example 7. For rods 8a-c, the secondary wash process was required as outlined in Example 7a-c. Characterization data is compiled in Table 6 for representative rods.

TABLE 6

| | Monolith | | |
|---|---|---|---|
| | Starting | | Surface Coverage of |
| Example | Material | % C | ODS (μmol/m²) |
| 7a | 1a | 22.95 | 1.99 |
| 7b | 4a | 24.46 | 2.22 |
| 7c | 4b | 24.44 | 2.21 |
| 7d | 1b | 15.46 | 0.91 |
| 7e | 4c | 24.30 | 2.16 |
| 8a | 2a | 17.51 | 3.19 |
| 8b | 5a | 17.11 | 3.05 |
| 8c | 5b | 15.87 | 2.86 |
| 8d | 2b | 18.44 | 3.43 |
| 8e | 5c | 14.60 | 2.70 |

Equivalents

Those skilled in the art will recognize, or be able to ascertain using no more than routine experimentation, numerous equivalents to the specific procedures described herein. Such equivalents are considered to be within the scope of this invention and are covered by the following claims. The contents of all references, issued patents, and published patent applications cited throughout this application are hereby incorporated by reference.

Incorporation by Reference

The entire contents of all patents, published patent applications and other references cited herein are hereby expressly incorporated herein in their entireties by reference.

1. A material for chromatographic separations comprising a porous inorganic/organic hybrid monolith, said monolith having and an interior area and an exterior surface, wherein said monolith is represented by:
[A]_{y}[B]ₓ (Formula I),
wherein x and y are whole number integers and A is
SiO₂/(R¹ₚR²_{q}SiOₜ)ₙ (Formula II) and/or SiO₂/[R³(R¹ᵣSiOₜ)ₘ]ₙ (Formula III);
wherein R¹ and R² are independently a substituted or unsubstituted C₁ to C₇ alkyl group, or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2; and n is a number from 0.01 to 100;
B is:
SiO₂/(R⁴ᵥSiOₜ)ₙ (Formula IV)
wherein R⁴ is hydroxyl, fluorine, alkoxy, aryloxy, substituted siloxane, protein, peptide, carbohydrate, nucleic acid, or combinations thereof, R⁴ is not R¹, R², or R³; v is 1 or 2, provided that when v=1, t=1.5, and when v=2, t=1; and n is a number from 0.01 to 100;
said interior of said monolith having a composition of A; said exterior surface of said monolith having a composition represented by A and B, and wherein said exterior composition is between about 1 and about 99% of the composition of B and the remainder comprising A.

2. The material of claim 1 wherein said exterior surface has a composition that is between about 50 and about 90% of composition B, with the remainder comprising composition A.

3. The material of claim 1 wherein said exterior surface has a composition that is between about 70 and about 90% of composition B, with the remainder comprising composition A.

4. The material of claim 1 wherein R⁴ is hydroxyl.

5. The material of claim 1 wherein R⁴ is fluorine.

6. The material of claim 1 wherein R⁴ is methoxy.

7. The material of claim 1 wherein R⁴ is
—OSi(R⁵)₂—R⁶ (Formula V)
wherein R⁵ is a C₁ to C₆ straight, cyclic, or branched alkyl, aryl, or alkoxy group, a hydroxyl group, or a siloxane group, and R⁶ is a C₁ to C₃₆ straight, cyclic, or branched alkyl, aryl, or alkoxy group, wherein R⁶ is unsubstituted or substituted with one or more moieties selected from the group consisting of halogen, cyano, amino, diol, nitro, ether, carbonyl, epoxide, sulfonyl, cation exchanger, anion exchanger, carbamate, amide, urea, peptide, protein, carbohydrate, nucleic acid functionalities, and combinations thereof.

8. The material of claim 7 wherein R⁶ is a C₁₈ group.

9. The material of claim 7 wherein R⁶ is a cyanopropyl group.

10. The material of claim 1, having a specific surface area of about 50 to about 800 m²/g.

11. The material of claim 1, having a specific surface area of about 190 to about 520 m²/g.

12. The material of claim 1, having specific pore volumes of about 0.5 to about 2.5 cm³/g.

13. The material of claim 1, having specific pore volumes of about 1 to about 2 cm³/g.

14. The material of claim 1, having an average pore diameter of about 35 to 500 Å.

15. The material of claim 1, having an average pore diameter of about 100 to 300 Å.

16. The material of claim 1, having been surface modified by polymer coating.

17. (canceled)

18. (canceled)

19. The material of claim 7, having a surface concentration of R⁶ greater than about 1.0 μmol/m².

20. The material of claim 7, having a surface concentration of R⁶ greater than about 2.0 μmol/m².

21. The material of claim 7, having a surface concentration of R⁶ greater than about 3.0 μmol/m².

22. The material of claim 7, having a surface concentration of R⁶ between about 1.0 and 3.4 μmol/m².

23. The material of claim 20, having a specific surface area of about 50 to about 800 m²/g.

24. The material of claim 20, having a specific surface area of about 190 to about 520 m²/g.

25. The material of claim 20, having specific pore volumes of about 0.5 to about 2.5 cm³/g.

26. The material of claim 20, having specific pore volumes of about 1 to about 2 cm³/g.

27. The material of claim 20, having an average pore diameter of about 35 to 500 Å.

28. The material of claim 20, having an average pore diameter of about 100 to 300 Å.

29. The material of claim 20, which have been surface modified by polymer coating.

30. A method of performing a separation comprising contacting a sample with the material of claim 1.

31. The method of claim 29, wherein the sample is passed through a chromatographic column containing the material of claim 1.

32. A separation device comprising the material of claim 1.

33. The separation device of claim 30, said device is selected from the group consisting of chromatographic columns, thin layer chromatographic plates, filtration membranes, sample clean up devices, solid phase organic synthesis supports, and microtiter plates.

34. The material of claim 1, wherein the monolith has a chromatographically enhancing pore geometry.

35. (canceled)

36. A method of preparing a material for chromatographic separations of claim 1, the method comprising:
a) preparing an aqueous solution of a mixture of one or more organoalkoxysilanes and a tetraalkoxysilane in the presence of an acid catalyst, and a surfactant or combination of surfactants to produce a polyorganoalkoxysiloxane;
b) incubating said solution, resulting in a three-dimensional gel having a continuous, interconnected pore structure;
c) aging the gel at a controlled pH and temperature to yield a solid monolith material;
d) rinsing the monolith material with an aqueous basic solution at an elevated temperature;
e) rinsing the monolith material with water followed by a solvent exchange;
f) drying the monolith material at room temperature drying and at an elevated temperature under vacuum; and
g) replacing one or more surface C₁ to C₇ alkyl groups, substituted or unsubstituted aryl groups, substituted or unsubstituted C₁ to C₇ alkylene, alkenylene, alkynylene, or arylene groups of the monolith with hydroxyl, fluorine, alkoxy, aryloxy, or substituted siloxane groups.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. A material for chromatographic separations of claim 1 comprising a porous inorganic/organic hybrid monolith, said monolith having and an interior area and an exterior surface, wherein said monolith is represented by:
[A]_{y}[B]ₓ (Formula I),
wherein x and y are whole number integers and A is
SiO₂/(R¹ₚR²_{q}SiOₜ)ₙ (Formula II) and/or SiO₂/[R³(R¹ᵣSiOₜ)ₘ]ₙ (Formula III);
wherein R¹ and R² are independently a substituted or unsubstituted C₁ to C₇ alkyl group, or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2; and n is a number from 0.01 to 100;
B is:
SiO₂/(R⁴ᵥSiOₜ)ₙ (Formula IV)
wherein R⁴ is hydroxyl, fluorine, alkoxy, aryloxy, substituted siloxane, protein, peptide, carbohydrate, nucleic acid, or combinations thereof, R⁴ is not R¹, R², or R³; v is 1 or 2, provided that when v=1, t=1.5, and when v=2, t=1; and n is a number from 0.01 to 100;
said interior of said monolith having a composition of A; said exterior surface of said monolith having a composition represented by A and B, and wherein said exterior composition is between about 1 and about 99% of the composition of B and the remainder comprising A;
said material prepared by a process comprising:
a) preparing an aqueous solution of a mixture of one or more organoalkoxysilanes and a tetraalkoxysilane in the presence of an acid catalyst, and a surfactant or combination of surfactants to produce a polyorganoalkoxysiloxane;
b) incubating said solution, resulting in a three-dimensional gel having a continuous, interconnected pore structure;
c) aging the gel at a controlled pH and temperature to yield a solid monolith material;
d) rinsing the monolith material with an aqueous basic solution at an elevated temperature;
e) rinsing the monolith material with water followed by a solvent exchange;
f) drying the monolith material at room temperature drying and at an elevated temperature under vacuum; and
g) replacing one or more surface C₁ to C₇ alkyl groups, substituted or unsubstituted aryl groups, substituted or unsubstituted C₁ to C₇ alkylene, alkenylene, alkynylene, or arylene groups of the monolith with hydroxyl, fluorine, alkoxy, aryloxy, or substituted siloxane groups.

53. A method of forming a porous inorganic/organic hybrid monolith comprising:
(a) forming a porous inorganic/organic hybrid monolith having surface silicon-alkyl groups;
(b) replacing one or more surface silicon-alkyl groups of the hybrid monolith with hydroxyl groups;
(c) replacing one or more surface silicon-alkyl groups with halo groups;
(d) bonding one or more substituted siloxane groups to the surface of the hybrid monolith; and
(e) end-capping the surface of the hybrid monolith with trialkylhalosilane.

54. (canceled)

55. (canceled)

56. (canceled)
